(19) United States
(12) Patent Application Publication
(10) Pub. No.: US 2003/0107982 A1
(43) Pub. Date: Jun. 12, 2003

(54) Position adjusting screw and optical disk player employing the same

(76) Inventor: Yosuke Kiyoto, Nagano (JP)

Correspondence Address: BIRCH STEWART KOLASCH & BIRCH, PO BOX 747, FALLS CHURCH, VA, 22040-0747, US

(21) Appl. No.: 10/300,900

(22) Filed: Nov. 21, 2002

(30) Foreign Application Priority Data
Dec. 10, 2001 (JP) 2001-375170

(51) Int. Cl. G11B 23/00; G11B 25/00

(52) U.S. Cl. 369/263

(57) ABSTRACT

The position adjusting screw is capable of precisely adjusting a position of an object member. The position adjusting screw comprises a screw section, which is screwed with a first member and a front end of the screw section, which is projected from the first member and which contacts a second member so as to relatively adjust a position of the second member with respect to the first member. The front end point-contacts the second member. A distance between the front end and the first member is in proportion to a rotational angle of the screw section.

### BACKGROUND OF THE INVENTION

The present invention relates to a position adjusting screw and an optical disk player employing the position adjusting screw.

Conventionally, ordinary screws have been used as position adjusting screws. Namely, a position of a structural member is adjusted by adjusting a projecting length of a screw.

In an optical disk player, for example, an angle of laser beam, which is irradiated from an optical pick-up toward an optical disk, is precisely controlled by a position adjusting screw. To precisely control the beam angle, the position adjusting screw, which merely has a fine pitch.

In most conventional position adjusting screws, a front end is cut along a line perpendicular to an axial line of the screw. In some conventional screws, a front end is cut along a line merely crossing an axial line of the screw. An example of the conventional position adjusting screw is shown in FIG. 8. The position adjusting screw 110 is screwed with and projected from a fixed member 126. A front end 110a of a screw section 110b always contacts a movable member 120. By turning the screw 110, a position of the movable member 120 with respect to the fixed member 126 can be adjusted. Namely, the position adjusting screw 110 is capable of relatively adjusting the position of the two members 120 and 126.

However, the front end 110a of the screw 110 is not a planar face, so different parts of the front end 110a contact the member 120 as shown in FIG. 9. Since different parts of the front end 110a contact the member 120, a distance between the two members 120 and 126 is slightly varied. Therefore, the distance is not in proportion to a rotational angle of the screw 110, so that it is difficult to precisely control the relative positions of the two members 120 and 126. Further, the front end 110a having the rough face damages the movable member 120.

### SUMMARY OF THE INVENTION

An object of the present invention is to provide a position adjusting screw capable of precisely adjusting a position of an object member.

Another object is to provide an optical disk player employing the position adjusting screw.

To achieve the objects, the present invention has following structures.

The position adjusting screw of the present invention comprises:

a screw section, which is screwed with a first member; and

a front end of the screw section, which is projected from the first member and which contacts a second member so as to relatively adjust a position of the second member with respect to the first member,

wherein the front end point-contacts the second member, and

wherein a distance between the front end and the first member is in proportion to a rotational angle of the screw section.

With this structure, the distance between the front end and the first member is in proportion to the rotational angle of the screw section, so that the relative position of the second member with respect to the first member can be precisely adjusted by controlling the rotational angle of the screw section.

In the position adjusting screw, the front end may be formed into a half-sphere.

With this structure, the front end of the screw section never damages the second member.

On the other hand, the optical disk player of the present invention comprises:

a chassis;

a mounting member being attached to the chassis;

a spindle motor being attached to the mounting member, the spindle motor having an output shaft to which a turn table for holding an optical disk is attached;

an optical pick-up being provided to the chassis, the optical pick-up irradiating a laser beam toward the optical disk set on the turn table;

a standard spacing member being provided between the chassis and the mounting member so as to define a standard clearance therebetween;

a biasing mechanism biasing the mounting member toward the chassis so as to always make the mounting member contact the standard spacing member; and

a position adjusting screw for adjusting the clearance between the chassis and the mounting member and adjusting a slope angle of the mounting member with respect to the chassis,

wherein the position adjusting screw comprises a screw section, which is screwed with the mounting member, and a front end of the screw section, which is projected from the mounting member and which contacts the chassis so as to adjust a position of the mounting member with respect to the chassis,

wherein the front end always point-contacts the chassis, and

wherein a distance between the front end and the mounting member is in proportion to a rotational angle of the screw section.

Another optical disk player of the present invention comprises:

a chassis;

a mounting member being attached to the chassis;

a spindle motor being attached to the chassis, the spindle motor having an output shaft to which a turn table for holding an optical disk is attached;

an optical pick-up being provided to the mounting member, the optical pick-up irradiating a laser beam toward the optical disk set on the turn table;

a standard spacing member being provided between the chassis and the mounting member so as to define a standard clearance therebetween;

a biasing mechanism biasing the mounting member toward the chassis so as to always make the mounting member contact the standard spacing member; and

a position adjusting screw for adjusting the clearance between the chassis and the mounting member and adjusting a slope angle of the mounting member with respect to the chassis,

wherein the position adjusting screw comprises a screw section, which is screwed with the mounting member, and a front end of the screw section, which is projected from the mounting member and which contacts the chassis so as to adjust a position of the mounting member with respect to the chassis,

wherein the front end always point-contacts the chassis, and

wherein a distance between the front end and the mounting member is in proportion to a rotational angle of the screw section.

In the optical disk player of the present invention, the distance between the front end and the mounting member is in proportion to the rotational angle of the screw section, so that an angle of the laser beam irradiated by the optical pick-up can be precisely adjusted by controlling the rotational angle of the screw section.

In the optical disk player, the front end of the position adjusting screw may be formed into a half-sphere.

In the optical disk player, the standard spacing member may be a spacer or a projection formed in the chassis.

### BRIEF DESCRIPTION OF THE DRAWINGS

Embodiments of the present invention will now be described by way of examples and with reference to the accompanying drawings, in which:

FIG. 1 is a side view of a position adjusting screw of an embodiment of the present invention;

FIG. 2 is a side view of a position adjusting screw of another embodiment;

FIG. 3 is an explanation view, wherein the position adjusting screw is employed in an optical disk player so as to adjust a position of a spindle motor;

FIG. 4 is a plan view of a laser beam angle adjusting mechanism of the optical disk player;

FIG. 5 is a sectional view taken along a line X-X shown in FIG. 4;

FIG. 6 is a rear view of another laser beam angle adjusting mechanism of the optical disk player;

FIGS. 7A and 7B are partial side views of the position adjusting screws of other embodiments; and

FIG. 8 is an explanation view of the conventional position adjusting screw; and

FIG. 9 is a partial enlarged view of the conventional position adjusting screw shown in FIG. 8.

### DETAILED DESCRIPTION OF THE EMBODIMENTS

Preferred embodiments of the present invention will now be described in detail with reference to the accompanying drawings.

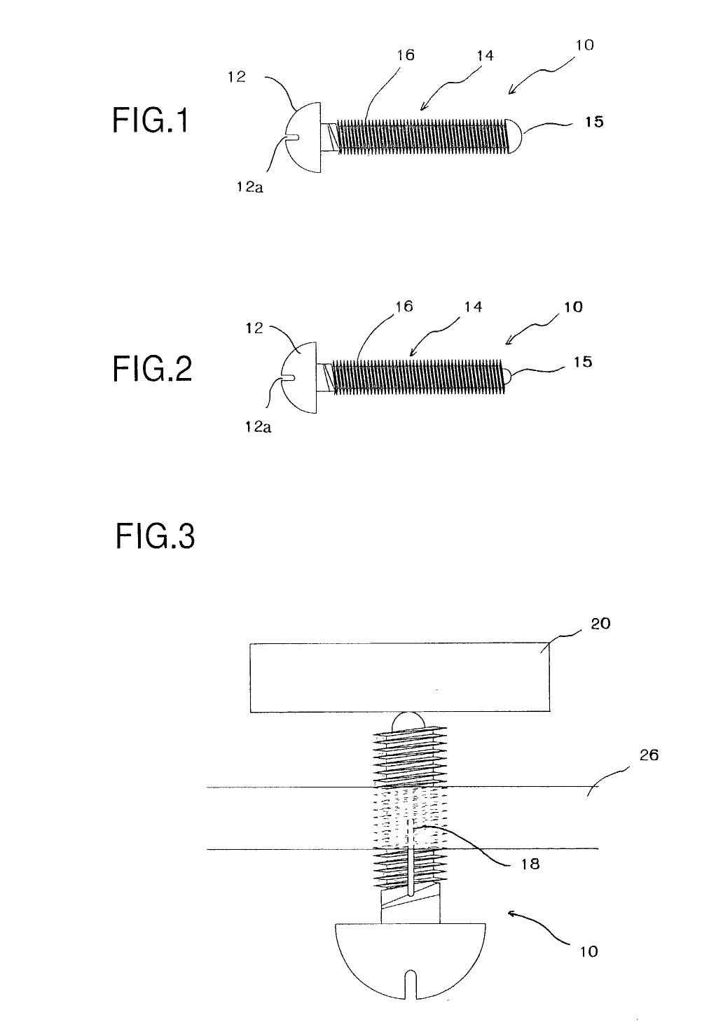

A position adjusting screw of an embodiment is shown in FIG. 1. The screw 10 has a head section 12 and a screw section 14. The both sections 12 and 14 are integrated. A plus(+)-shaped groove 12a, to which a front end of a plus-driver can be fit, is formed in the head section 12.

A thread 16 is spirally formed on a whole outer circumferential face of the screw section 14. A front end 15 of the screw section 14 is formed into a half-sphere, so that the front end 15 point-contacts an object article or an object member. In the present embodiment, an outer diameter of the screw section 14 is equal to the maximum diameter of the half-sphere front end 15, but the outer diameter of the screw section 14 may be greater than the maximum diameter of the half-sphere front end 15 as shown in FIG. 2.

In FIG. 3, the position adjusting screw 10 is used for adjusting a distance between a spindle motor 20, which is an example of a second member, and a mounting plate 26, which is an example of a first member. The screw 10 is screwed with the mounting plate 26, and the screw section 14 is projected therefrom. The distance can be adjusted by controlling a projecting length of the screw section 14. Since the front end 15 is formed into the half-sphere, the front end always point-contacts the spindle motor 20. Further, the distance between the front end 15 and the mounting plate 26 is in proportion to a rotational angle of the screw section 14, so that the distance or the relative position of the spindle motor 20 with respect to the mounting plate 26 can be easily precisely adjusted.

As shown in FIG. 3, a groove 18 for injecting a locking agent is grooved in the screw section 14. With this structure, the locking agent can be applied between the screw section 14 and the mounting plate 26, so that the screw 10 is not loosened by vibration of the spindle motor 20. By applying the locking agent, the position of the screw 10 can be fixed, so further position adjustment can be omitted. An upper end of the groove 18 reaches a mid part of the mounting plate 26. With this structure, the spindle motor 20 can be easily exchanged.

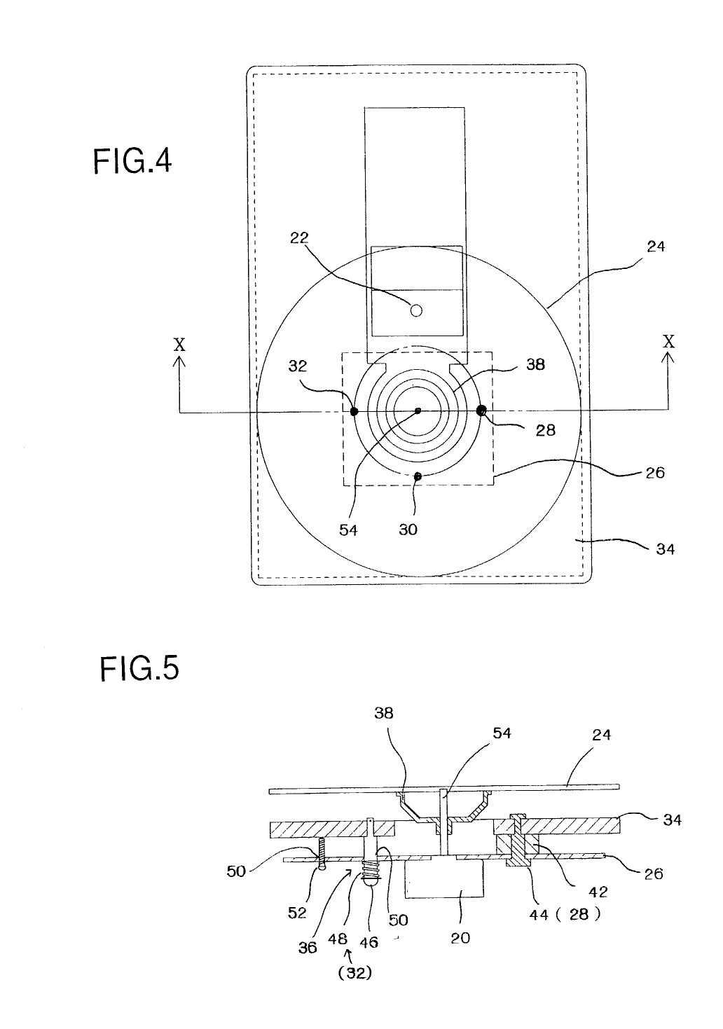

Successively, a laser beam angle adjusting mechanism of an optical disk player will be explained with reference to FIGS. 4 and 5. FIG. 4 is a plan view of the laser beam angle adjusting mechanism; FIG. 5 is a sectional view taken along a line X-X shown in FIG. 4. The position adjusting screw of the present invention are employed in the mechanism.

By employing the mechanism, an angle of a laser beam irradiated from an optical pick-up 22 toward an optical disk 24 can be adjusted. A spindle motor 20 is fixed to a mounting plate 26, which acts as a mounting member. The mounting plate 26 is supported at a standard supporting section 28 and adjustable supporting sections 30 and 32, so that the mounting plate 26 can be inclined with respect to a chassis 34. A biasing mechanism 36 always biases the mounting plate 26 toward the chassis 34. In this state, the inclination of the mounting plate 26 with respect to the chassis 34 can be adjusted at the adjustable supporting sections 30 and 32. By adjusting the inclination, the angle of the laser beam irradiated from the optical pick-up 22 toward the optical disk 24 can be adjusted.

At the standard supporting section 28, a clearance between the mounting plate 26 and the chassis 34 is fixed as a standard clearance. On the other hand, at the adjustable supporting sections 30 and 32, the clearance between the mounting plate 26 and the chassis 34 can be adjusted.

An example of adjusting the laser beam angle will be explained. The mounting plate 26 is supported at the supporting sections 28, 30 and 32 and can be inclined with respect to the chassis 34.

At the standard supporting section 28, a spacer 42, which is acts as a standard spacing member, is provided between the chassis 34 and the mounting plate 26 so as to define the fixed standard clearance. The spacer 42 is fixed by a rivet 44. Note that, other means, e.g., a projection formed in the chassis 34, may be employed as the standard spacing member.

The biasing mechanism 36 includes a screw 46 and an elastic member 48, e.g., a coil spring. The elastic member 48 always biases the mounting plate 26 toward the chassis 34.

Two screw holes 50 are formed in the mounting plate 26, and they respectively correspond to the adjustable supporting sections 30 and 32. Two position adjustable screws 52, whose front ends contact the chassis 34, are respectively screwed in the screw holes 50 so as to adjust the clearance between the mounting plate 26 and the chassis 34.

If the adjusting screws 52 are the screws having fine pitch (see FIGS. 1 and 2), the clearance between the mounting plate 26 and the chassis 34 can be easily precisely adjusted.

Next, a method of adjusting the laser beam angle of the optical pick-up 22 will be explained. Firstly, the adjusting screws 52, which are respectively provided to the adjustable supporting sections 30 and 32, are turned to move with respect to the mounting plate 26 so as to vary the clearance between the mounting plate 26 and the chassis 34 at the adjustable supporting sections 30 and 32. However, the clearance at the standard supporting section 28 is fixed. Therefore, the inclination angle of the mounting plate 26 with respect to the chassis 34 can be varied by the adjusting screws 52. By adjusting the inclination of the mounting plate 26 with respect to the chassis 34, the spindle motor 20 fixed to the mounting plate 26 can be inclined with respect to the chassis 34. A turn table 38 is fixed to an output shaft 54 of the spindle motor 20, so the turn table 38 too is inclined together with the output shaft 54 of the spindle motor 20. Namely, the optical disk 24 held on the turn table 38 is inclined with respect to the optical pick-up 22. With this structure, the angle of the laser beam irradiated by the optical pick-up 22 can be adjusted.

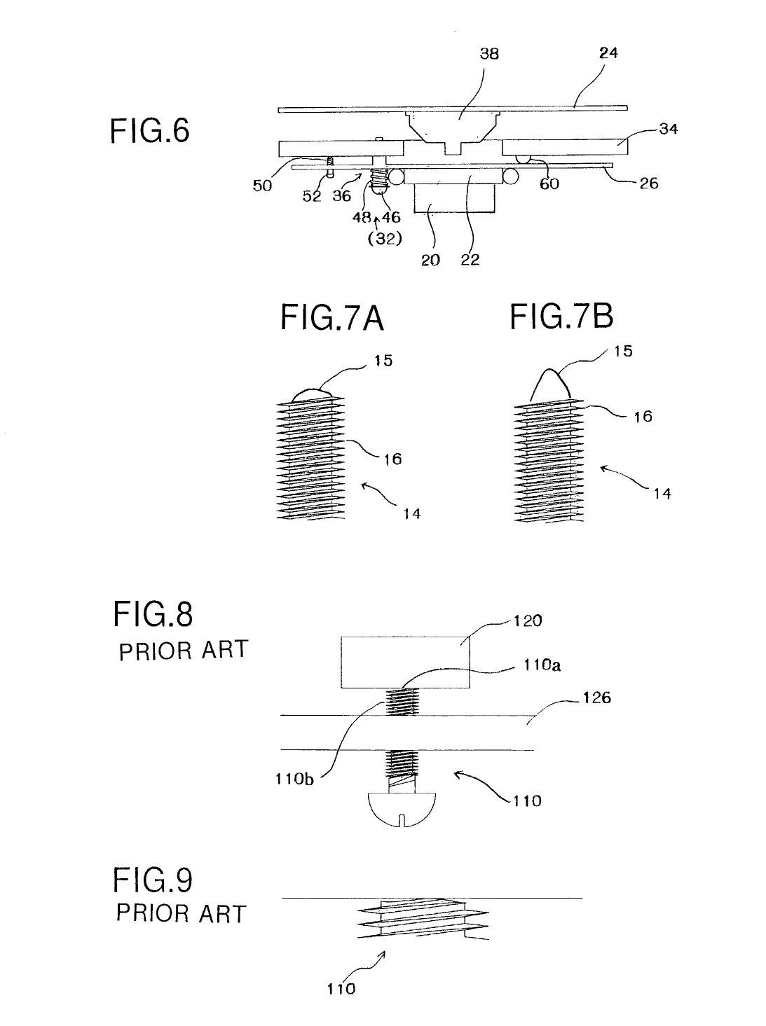

Another laser beam adjusting mechanism of the optical disk player is shown in FIG. 6. Note that, the structural elements shown in FIGS. 4 and 5 are assigned the same symbols and explanation will be omitted. In this example, the optical pick-up 22 is attached to the mounting plate 26. A projection 60 is formed in the chassis 34 or the mounting plate 26 as the standard spacing member. The projection 60 corresponds to the standard supporting section. The position adjusting screws 52 are respectively provided at the adjustable supporting sections as well as the example shown in FIGS. 4 and 5.

In this example too, the mounting plate 26 can be inclined with respect to the chassis 34 by adjusting the projection length of the screws 52 from the mounting plate 26. By inclining the mounting plate 26, a slope angle or an inclination angle of the optical pick-up 22, which is slidably attached to the mounting plate 26, can be varied with respect to the turn table 38, which is fixed to the output shaft of the spindle motor 20. Therefore, the angle of the laser beam, which is irradiated from the optical pick-up 22, with respect to the optical disk 24, which is held on the turn table 38, can be adjusted.

Note that, in this example, the spindle motor 20 and the turn table 38 should be arranged parallel to the chassis 34.

In the optical disk player of the both examples, the locking agent may be applied into the grooves 18 (see FIG. 3) of the position adjusting screws 52 after the laser beam angle is adjusted. By applying the locking agent, the screws 52 will never be loosened by vibration caused by the spindle motor 20 and the rotation of the optical disk 24, therefore readjustment of the laser beam angle is not required after the locking agent is applied in an assembling step.

Note that, the present invention is not limited to the above described embodiments. For example, the shape of the front end 15 may be formed like a dome shape (see FIG. 7A) and a cone shape (see FIG. 7B). In the case shown in FIG. 7B, a chip of the front end 15 is rounded so as not damage an object member.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. A position adjusting screw, comprising:
a screw section, which is screwed with a first member; and
a front end of said screw section, which is projected from the first member and which contacts a second member so as to relatively adjust a position of the second member with respect to the first member,
wherein said front end point-contacts the second member, and
wherein a distance between said front end and the first member is in proportion to a rotational angle of said screw section.

2. The position adjusting screw according to claim 1,
wherein said front end is formed into a half-sphere.

3. An optical disk player, comprising:
a chassis;
a mounting member being attached to said chassis;
a spindle motor being attached to said mounting member, said spindle motor having an output shaft to which a turn table for holding an optical disk is attached;
an optical pick-up being provided to said chassis, said optical pick-up irradiating a laser beam toward the optical disk set on the turn table;
a standard spacing member being provided between said chassis and said mounting member so as to define a standard clearance therebetween;
a biasing mechanism biasing said mounting member toward said chassis so as to always make said mounting member contact said standard spacing member; and
a position adjusting screw for adjusting the clearance between said chassis and said mounting member and adjusting a slope angle of said mounting member with respect to said chassis,
wherein said position adjusting screw comprises a screw section, which is screwed with said mounting member, and a front end of the screw section, which is projected from said mounting member and which contacts said chassis so as to adjust a position of said mounting member with respect to said chassis,
wherein the front end always point-contacts said chassis, and
wherein a distance between the front end and said mounting member is in proportion to a rotational angle of the screw section.

4. The optical disk player according to claim 3,
wherein the front end of said position adjusting screw is formed into a half-sphere.

5. The optical disk player according to claim 3,
wherein said standard spacing member is a spacer.

6. The optical disk player according to claim 3,
wherein said standard spacing member is a projection formed in said chassis.

7. An optical disk player, comprising:
a chassis;
a mounting member being attached to said chassis;
a spindle motor being attached to said chassis, said spindle motor having an output shaft to which a turn table for holding an optical disk is attached;
an optical pick-up being provided to said mounting member, said optical pick-up irradiating a laser beam toward the optical disk set on the turn table;
a standard spacing member being provided between said chassis and said mounting member so as to define a standard clearance therebetween;
a biasing mechanism biasing said mounting member toward said chassis so as to always make said mounting member contact said standard spacing member; and
a position adjusting screw for adjusting the clearance between said chassis and said mounting member and adjusting a slope angle of said mounting member with respect to said chassis,
wherein said position adjusting screw comprises a screw section, which is screwed with said mounting member, and a front end of the screw section, which is projected from said mounting member and which contacts said chassis so as to adjust a position of said mounting member with respect to said chassis,
wherein the front end always point-contacts said chassis, and
wherein a distance between the front end and said mounting member is in proportion to a rotational angle of the screw section.

8. The optical disk player according to claim 7,
wherein the front end of said position adjusting screw is formed into a half-sphere.

9. The optical disk player according to claim 7,
wherein said standard spacing member is a spacer.

10. The optical disk player according to claim 7,
wherein said standard spacing member is a projection formed in said chassis.
